(19) United States
(12) Patent Application Publication
(10) Pub. No.: US 2003/0230436 A1
(43) Pub. Date: Dec. 18, 2003

(54) Automatic mailing machine and method of handling postal items

(76) Inventor: Styrbjorn Garde, Paris (FR)

Correspondence Address: YOUNG & THOMPSON, 745 SOUTH 23RD STREET 2ND FLOOR, ARLINGTON, VA, 22202

(21) Appl. No.: 10/414,222

(22) Filed: Apr. 16, 2003

(30) Foreign Application Priority Data
Apr. 16, 2002 (SE) 0201178-1

(51) Int. Cl. G01G 19/40

(52) U.S. Cl. 177/25.15; 705/407

(57) ABSTRACT

An automatic machine (10) for handling postal items, said automatic machine (10) comprising an opening for receiving a postal item, a scale means (18) arranged in connection with the opening and operable to measure the weight of the postal item, a reader (20) arranged in connection with the opening and operable to read text on the postal item, a computer means (16) connected to the scale means (18) and the reader (20), which computer means, depending on the weight and the text on the postal item, determine the appropriate postage for the postal item, said postage being shown on a display (22) included in the automatic machine, said automatic machine (10) also comprising a payment means (24) connected to the computer means (16) for payment of the postage shown, a franking or metering means (26) connected to the computer means (16), for franking the postal item when the postage has been paid, and a storage space included in the automatic machine (10) for franked postal items.

### FIELD OF THE INVENTION

The present invention relates, in a first aspect, to an automatic machine for handling postal items.

According to another aspect, the present invention relates to a method of handling postal items.

### BACKGROUND OF THE INVENTION

The handling of postal items, such as letters and parcels, is largely manual today. Beyond the fact that the manual handling is quite costly, it is difficult to maintain high security. It is difficult, for example, to discover and prevent the posting of letter bombs, for example,

### SUMMARY OF THE INVENTION

The present invention intends to:

1. simplify the process of postage metering or franking of postal items by the machine described herein, postage metering them instead of affixing stamps or the like;

2. assure the correctness of the postage metering or franking and reporting to the owner of the machine, for example, the correct sum without any deductions;

3. eliminate cheating and dishonesty when franking postal items by virtue of the checking made possible of outgoing postal items with regard to destination address and origin;

4. supply the market with a new technically secure aid so that the full income of the franking activity will go to the owner of the machine or the like; and

5. substantially reduce the hitherto occurring high costs of franking at post offices or tie like.

It is a purpose of the present invention to solve the above mentioned problems.

According to the present invention, an automatic machine is achieved for handling postal items. The machine comprises an opening for receiving a postal item. The machine also comprises a scale arranged in connection to the opening and which is operable to measure the weight of the postal item. The machine also comprises a reader arranged in connection with the opening, operable to read text on the postal item. The machine also comprises a computer means connected to the scale and the reader. Depending on the weight and the text on the postal item, the computer means determine the appropriate postage for the postal item and display the postage on the machine's display. The machine also comprises a payment means connected to the computer means for payment of the postage shown. The machine also comprises a franking means connected to the computer means for franking postal items when the postage has been paid. The machine also comprises a storage space for franked postal items.

An advantage in this context is obtained if the machine 10 also includes a means for entering alphanumeric characters which is connected to the computer means 16.

In this context an advantage is obtained if the reader 20 is an optical reader 20.

An advantage in this context is obtained if the machine 10 also comprises X-ray means connected to the computer means 16 and disposed near the opening 12, which are operable for X-raying said postal items.

In this context there is an advantage if the machine 10 returns a postal item via the opening 12 if the address is missing or cannot be read and/or if the demanded postage has not been paid.

An advantage in this context is obtained if the payment means 24 permits cash payment and/or card payment.

In this context an advantage is obtained if the franking means prints the suitable postage on the item after payment.

According to another aspect of the present invention, a process is obtained for handling postal items by means of a machine comprising an opening. The process comprises the steps of:

receiving a postal item in the opening;

via a scale means included in the automatic machine, measuring the weight of the postal item;

via a reader included in the automatic machine, reading text on the postal item;

determining the appropriate postage for the postal item;

receiving payment of the appropriate postage, and

by means of a ranking means included in the automatic machine, franking the postal item.

An advantage in this context is obtained if the process also comprises the step of:

displaying the determined postage on a display included in the automatic machine.

In this context an advantage is obtained if the process also comprises the step of:

feeding in an address for a postal item via an entering means included in the automatic machine.

An advantage in this context is obtained if the step of reading a text is effected by means of an optical reader.

In this context an advantage is obtained if the process also comprises the steps of:

X-raying the postal item by means of X-rays; and

returning the postal item via the opening if a suspect contents is detected in the postal item in the step above.

An advantage in this context is obtained if the process also comprises the step of:

returning the postal item by the opening if an address is lacking or is illegible and/or if the required postage has not been paid.

In this context an advantage is obtained if the step of receiving payment is effected by means of payment means included in the machine 10, which permit cash payment and/or card payment.

The invention provides to the public in all countries the advantages which X-ray-examined postal items provide over conventional letter handling via post offices etc., where the risks are significant for terrorist attacks involving many victims and counter-measures are few. According to the invention, the postal item receives a quality stamp which follows the item during its continued handling and substantially facilitates security both in a national and international perspective. It is conceived that the new security-examined postal item will have a special label, e.g. “Security tested”. For the operator this involves an economic advantage. The quality-marked postal item can demand a higher postage than conventional letters. Furthermore, handling is simplified, making subsequent security checks unnecessary, at the same time as the recipient does not need to worry, as is the case with ordinary postal items, about opening a letter bomb.

Embodiments of the invention will now be described with reference to the accompanying drawings, where:

### SHORT DESCRIPTION OF THE DRAWINGS

FIG. 1 shows a perspective view of a machine for handling postal items in accordance with the present invention.

FIG. 2 shows a block diagram of the machine shown in FIG. 1; and

FIG. 3 is a flowchart of a process for handling postal items in accordance with the present invention.

### DETAILED DESCRIPTION OF EMBODIMENTS

The invention intended above is based on a system for automatic handling of postal items, for example.

In contrast to general procedures at present, the machine disclosed in the present patent application replaces the essentially manual franking which takes place at post offices or the like.

The machine also replaces postage meters or franking machines presently on the market, since these do not present a complete solution to processing outgoing post, from automatically franking the correct postage to transporting the postal item, all with high security requirements.

Savings of the operator can be generally considered to be significant. Satisfactory security routines can also be included in the computer program used by the machine.

The automatic machine is a box, which from the outside resembles a common postbox. On the inside its design and use are completely new and hitherto unknown. Instead of an opening for receiving franked postal items, the automatic machine has an opening which is 40 (width)×60 (height) centimeters in the standard version. It can be supplemented by other automatic machines with selected measures for smaller or larger postal items.

The size of the automatic machine is determined by the market at that location at which the machine is to be used and by the size of the postal items (letters or parcels etc.) as well as local differences and habits.

In the machine opening there is a compartment into which the postal item is placed face up.

A computer installed in the automatic machine reads the address and addressee on the postal item. The machine is also provided with a scale.

These are necessary to enable the computer to calculate firstly the weight of the postal item and the postal rates for the country to which the item is to be sent as well as special functions affecting the postage rates, e.g. certification, airmail etc.

When these price-affecting data have been determined, the postage is shown in the display window. It could be paid in by the sender in cash through a special slot.

The amount paid is stamped onto the item and a receipt is then printed out and delivered through a special slot on the machine.

The feeding slot opens inwards. The postal item ends up after franking in the machine storage space.

This can easily be combined with larger receiving units, e.g. at a post office.

If the postal item does not fulfil the above requirements, it is returned to the sender unfranked.

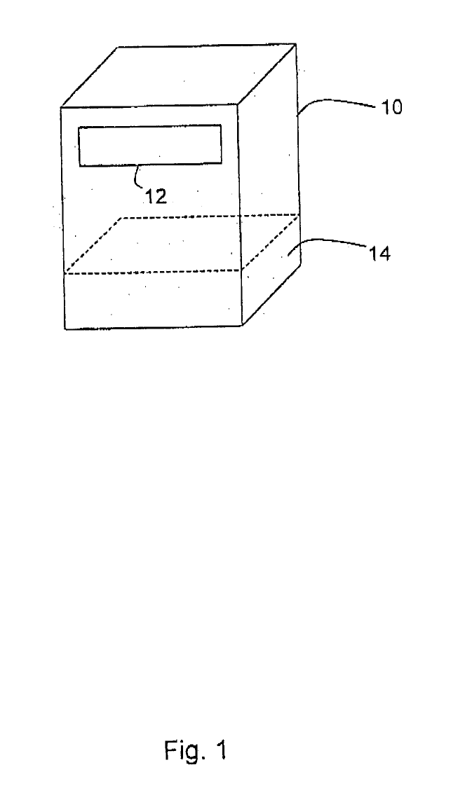

FIG. 1 shows a perspective view of an automatic machine 10 for handling postal items in accordance with the present invention. On the outside it resembles a common post box, with an opening 12 for receiving a postal item, such as a letter or parcel. As in indicated by the dashed line in FIG. 1, a portion of the machine 10 is a storage space 14 intended for franked or metered postal items.

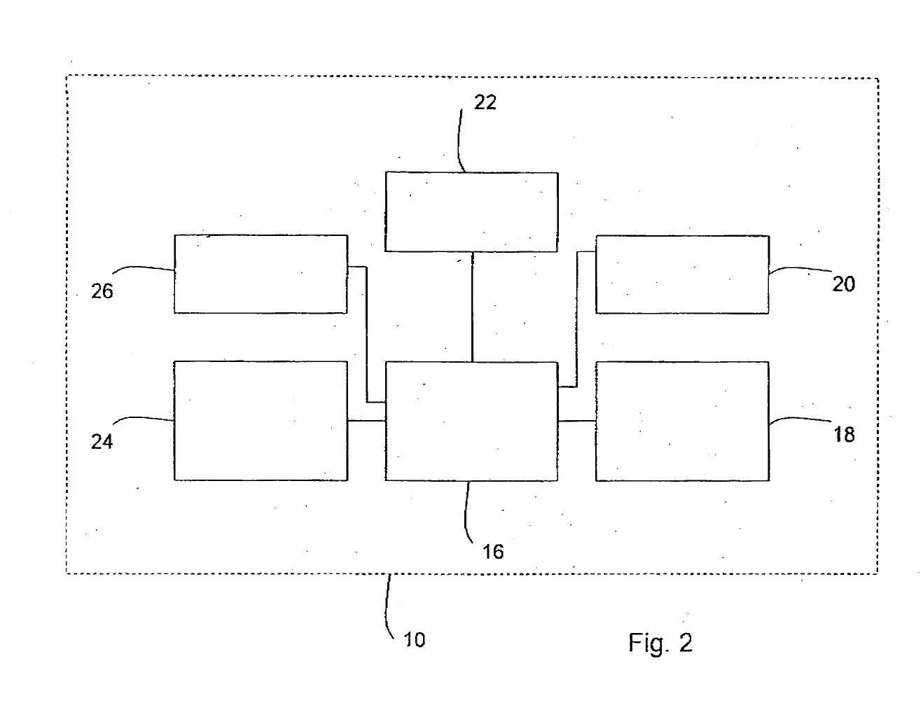

FIG. 2 shows a block diagram of the automatic machine 10 shown in FIG. 1. The automatic machine comprises a scale 18, operable to measure the weight of postal items received through the opening 12 (see FIG. 1). The scale 18 is arranged in connection with the opening 12. The automatic machine 10 also comprises a reader 20, which is operable to read text on the postal items. The reader 20 is also arranged in connection with the opening 12. A computer means 16 is connected to the scale 18 and to the reader 20 and determines, depending on the weight and the address on the postal item, the appropriate postage for the item. The machine 10 also comprises a display 22, connected to the computer means 16. The display 22 shows, for example, the appropriate postage determined by the computer means 16. A payment means 24 is also connected to the computer means 16. With the help of the payment means a customer can pay the appropriate postage for a postal item. The machine 10 also comprises a franking or postage metering means 26, which is operable to frank postal items when the postage has been paid. Franking means 26 are connected to the computer means 16.

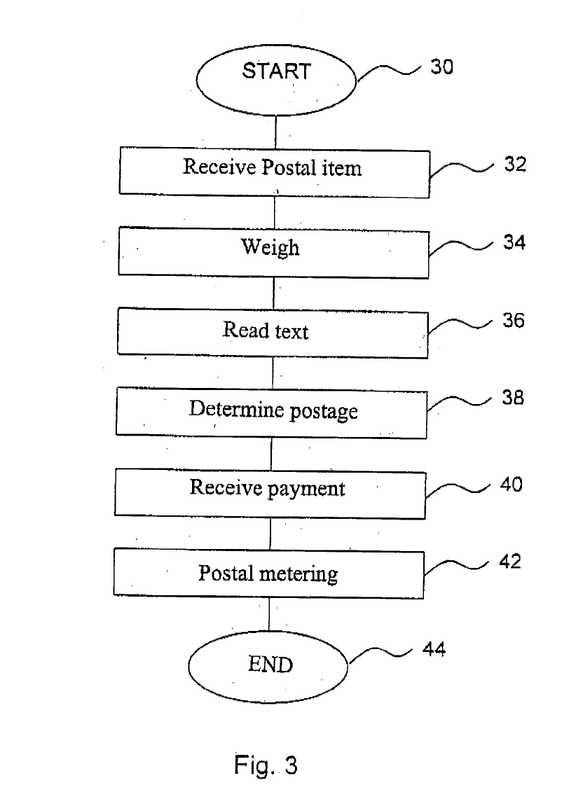

FIG. 3 shows a flowchart of a process for handling postal items in accordance with the present invention. The process is carried out by means of an automatic machine 10 (see FIGS. 1 and 2) comprising an opening 12. The process begins at block 30. The process then continues at block 32 with the step of receiving a postal item through the opening 12. The process then continues at block 34 with the step of determining the weight of the postal item by means of a scale 18, included in the automatic machine 10. The result is transferred to the computer means 16. The process continues then at block 36 with the step of reading, by means of a reader 20 included in the machine 10, the text on the postal item, preferably the address. The result of this reading is transferred to the computer means 16. The process then continues, at block 38, with the step of determining the correct postage for the postal item. The process then continues at block 40 with the step of receiving payment of the appropriate postage. The process then continues at block 42 with the step of franking the postal item by means of franking or metering means 26 included in the automatic machine 10. The process finally is concluded at block 44.

The invention is not limited to the embodiments described above. A person skilled in the art will readily realize that various modifications are possible within the scope of the accompanying claims.

1. An automatic machine (10) for handling postal items, said automatic machine (10) comprising an opening (12) for receiving a postal item, a scale means (18) arranged in connection with the opening (12) and operable to measure the weight of the postal item, a reader (20) arranged in connection with the opening (12) and operable to read text on the postal item, a computer means (16) connected to the scale means (18) and the reader (20), which computer means, depending on the weight and the text on the postal item, determine the appropriate postage for the postal item, said postage being shown on a display (22) included in the automatic machine, said automatic machine (10) also comprising a payment means (24) connected to the computer means (16) for payment of the postage shown, a franking or metering means (26) connected to the computer means (16), for franking the postal item when the postage has been paid, and a storage space (14) included in the automatic machine (10) for flanked postal items.

2. An automatic machine (10) for handling postal items in accordance with claim 1, characterized in that the automatic machine (10) also comprises an entering means connected to the computer means (16) for entering alphanumeric symbols.

3. An automatic machine (10) for handling postal items in accordance with one of claims 1-2, characterized in that the reader (20) is an optical reader (20).

4. An automatic machine (10) for handling postal items in accordance with one of claims 1-3, characterized in that the automatic machine (10) also comprises an X-ray means, connected to the computer means (16) and in connection to the opening (12), which X-ray means are operable to X-ray said postal items.

5. An automatic machine (10) for handling postal items in accordance with one of claims 1-4, characterized in that the automatic machine (10) returns a postal item via the opening (12) if the address is missing or cannot be read and/or if the specified postage has not been paid.

6. An automatic machine (10) for handling postal items in accordance with one of claims 1-5, characterized in that the payment means (24) permits cash payment and card payment.

7. An automatic machine (10) for handling postal items in accordance with one of claims 1-6, characterized in that the franking means print the appropriate postage on the postal item after payment.

8. A process for handling postal items by means of an automatic machine (10) comprising an opening (12), said process comprising the steps of:
receiving a postal item in the opening (12);
via a scale means (18) included in the automatic machine (10), measuring the weight of the postal item;
via a reader (20) included in the automatic machine (10), reading text on the postal item;
determining the appropriate postage for the postal item;
receiving payment of the appropriate postage; and
by means of a franking means (26) included in the automatic machine (10), franking the postal item.

9. A process for handling postal items in accordance with claim 8, characterized in that the process also comprises the step of:
displaying the determined postage on a display (22) included in the automatic machine (10).

10. A process for handling postal items in accordance with one of claims 8-9, characterized in that the process also comprises the step of:
feeding in an address for a postal item via an entering means included in the automatic machine (10).

11. A process for handling postal items in accordance with one of claims 8-10, characterized in that the step of reading text is effected by means of an optical reader.

12. A process for handling postal items in accordance with one of claims 8-11, characterized in that the process also comprises the steps of:
X-raying the postal item by means of X-rays; and
returning the postal item via the opening (12) if a suspect contents is detected in the postal item in the step above.

13. A process for handling postal items in accordance with one of claims 8-12, characterized in that the process also comprises the step of:
returning the postal item by the opening (12) if an address is lacking or is illegible and/or if the required postage has not been paid.

14. A process for handling postal items in accordance with one of claims 8-13, characterized in that the step of receiving payment is effected by means of a payment means included in the automatic machine (10), which permits cash payment and payment by means of a card.
